(19) United States
(12) Patent Application Publication
(10) Pub. No.: US 2024/0095562 A1
(43) Pub. Date: Mar. 21, 2024

(54) COMPOSITE QUANTUM ARCHITECTURE FOR QUANTUM REALIZATION OF JORDAN-FORM BASED SYSTEMS

(71) Applicant: THE INDIAN INSTITUTE OF TECHNOLOGY, KHARAGPUR (IN)

(72) Inventors: Mostafizur Rahaman Laskar, Kharagpur (IN); Amit Kumar Dutta, Kharagpur (IN)

(21) Appl. No.: 18/097,221

(22) Filed: Jan. 14, 2023

(30) Foreign Application Priority Data
Aug. 29, 2022 (IN) 202231049314

(51) Int. Cl. G06N 10/20

(52) U.S. Cl. CPC G06N 10/20

(57) ABSTRACT

The invention provides a quantum elementary gate-based composite system comprising elementary quantum gates including Pauli operators and Singleton ladder operators. The Pauli operators and said Singleton ladder operators are operatively combined to form a Jordan Canonical form-based representation suitable for simulating large quantum matrices, specially structured matrices such as symmetric, and Toeplitz matrix.

### CROSS-REFERENCE TO RELATED APPLICATIONS:

This application claims priority to, and incorporates the contents herein, of Indian application number 202231049314, filed Aug. 29, 2022.

### FIELD OF THE INVENTION

The present invention relates to a novel quantum system. More specifically, the present invention is directed to a new quantum circuit for quantum realization of Jordan-form based systems whose super-diagonals are one (1) and rest elements are zero. The present quantum circuit system can be implemented using elementary quantum gates such as Pauli-X, Pauli-Y and singleton ladder operators and it will be computationally low-complex representation for sparse and structured systems. The proposed quantum circuit system has potential to represent large matrices in near-term quantum science and technology (QST).

### BACKGROUND OF THE INVENTION

Quantum technology is an emerging technology with a potential to revolutionize the computing facility at a great extent. The quantum systems are much faster in solving certain problems.

In quantum computation, quantum evolution is the process of evolving (or simulating) a quantum state (or state vector) with time, which preserve unitarity property to obey quantum reversibility. Quantum Hamiltonian simulation is a practical method of quantum evolution which helps to prepare a unitary operator from a Hermitian operator (or matrix) within a specified time, and a bounded error. The optimization problem for the Hamiltonian simulation is often written in the form as follows

∥U−e^{-iHt}∥₂<ϵ

Where U is the desired unitary operator, H is the system Hamiltonian (a Hermitian operator), t is the evolution time, and ϵ is the error in the approximation incurred by the Hamiltonian simulation.

The following prior arts indicate that sparse-based architecture augments significant quantum speed-up for the Hamiltonian simulation:

Low, G. H. and Chuang, I. L., 2017. Optimal Hamiltonian Simulation by Quantum Signal Processing. Physical review letters, 118(1), p.010501.

Low, G. H. and Chuang, I. L., 2019. Hamiltonian Simulation by Qubitization. Quantum, 3, p.163.

Berry, D. W., Childs, A. M., Cleve, R., Kothari, R. and Somma, R. D., 2017. Exponential Improvement in Precision for Simulating Sparse Hamiltonians. In Forum of Mathematics, Sigma (Vol. 5). Cambridge University Press.

The structured or sparse representation of systems such as a Jordan-canonical form (also known as Jordan matrix or Jordan block) is a matrix of the following form

$${J}_{λ} = [ \begin{matrix}λ & 1 & 0 & 0 \\ 0 & λ & ⋱ & 0 \\ ⋮ & ⋱ & ⋱ & 1 \\ 0 & … & 0 & λ\end{matrix} ]$$

where λ is eigenvalue of some matrix. A complex square matrix is often represented in Jordan normal form, which is a block-diagonal matrix, with every block in the diagonal are individually Jordan system having different eigen values. A 4×4 Jordan system for a zero-eigenvalue has the following form

$${J}_{0}^{4 \times 4} = [ \begin{matrix}0 & 1 & 0 & 0 \\ 0 & 0 & 1 & 0 \\ 0 & 0 & 0 & 1 \\ 0 & 0 & 0 & 0\end{matrix} ] .$$

The prior arts on Jordan system and their uses in large-system representation are as follows.

Mastronardi, N. and Dooren, P. V., 2017. Computing the Jordan Structure of an Eigenvalue. SIAM Journal on Matrix Analysis and Applications, 38(3), pp.949-966.

Vxliaho, H., 1986. An Elementary Approach to the Jordan Form of a Matrix. The American Mathematical Monthly, 93(9),pp.711-714.

M.-T. Chien, J. Liu, H. Nakazato, and T.-Y. Tam, “Toeplitz Matrices are Unitarily Similar to Symmetric Matrices,” Linear and Multilinear Algebra, vol. 65, no. 10, pp. 2131-2144,2017.

However, in the above-mentioned prior arts, involvement of the structured or sparse representation of systems (such as the Jordan-canonical form) for the quantum system is not properly addressed. Hence, there has been a need for developing a novel quantum system for implementing the Jordan-form system using elementary quantum gates.

### OBJECT OF THE INVENTION

It is thus the basic object of the present invention is to provide a quantum circuit system which would be a quantum realization of Jordan-form based systems whose super-diagonals are one (1) and rest elements are zero.

Another object of the present invention is to provide a quantum circuit system which can be implemented using elementary quantum gates such as Pauli-X, Pauli-Y and singleton ladder operators and it will be computationally low-complex representation for sparse and structured systems.

Another object of the present invention is to provide a quantum circuit system which can be used to represent large matrices in near-term quantum science and technology (QST).

### SUMMARY OF THE INVENTION

Thus according to the basic aspect of the present invention there is provided a quantum elementary gate-based composite system comprising

elementary quantum gates including Pauli operators and Singleton ladder operators;

said Pauli operators and said Singleton ladder operators are operatively combined to form a Jordan Canonical form-based representation suitable for simulating large quantum matrices, specially structured matrices such as symmetric, and Toeplitz matrix.

In a preferred embodiment of the present quantum elementary gate-based composite system, the Jordan Canonical form-based representation of size N×N for implementing large quantum matrices based systems with N>4 includes tensor operators for tensor product realizing

G₄Xⁱ₂⊗X^{j}₂

where G4∈ R^{4×4}, Xⁱ₂ and X^{j}₂ are two arbitrary quantum operators of size 2×2 such as the Pauli-gates and/or singleton operators;

wherein using tensor-products, augmented operators with higher dimensions (as a power of 2) is implemented by

$$\begin{matrix}{G}_{{2}^{n}}^{{C}_{1} {C}_{2}} = {G}_{{2}^{\frac{n}{2}}}^{{C}_{1}} ⊗ {G}_{{2}^{\frac{n}{2}}}^{{C}_{2}} \\ = {G}_{{2}^{k}}^{{C}_{1}} ⊗ {G}_{{2}^{n - k}}^{{C}_{1}} ∀ k ∈ ℤ\end{matrix}$$

where G^{C1C2} is an augmented operator of dimension N=2ⁿ, which is a tensor product of two smaller dimensional operators G^{C1} and G^{C2}.

In a preferred embodiment of the present quantum elementary gate-based composite system, the Jordan Canonical form-based representation of size 4×4 represented as:

$$\begin{matrix}( {J}_{4} ; ) = ( + 1 ) {G}_{4}^{{s}_{o} {l}_{L}} + ( + 1 ) {G}_{4}^{{s}_{1} {l}_{L}} + ( - 1 ) {G}_{4}^{{l}_{L} {l}_{L}} \\ = [ \begin{matrix}0 & 1 & 0 & 0 \\ 0 & 0 & 0 & 0 \\ 0 & 0 & 0 & 1 \\ 0 & 0 & 0 & 0\end{matrix} ] + [ \begin{matrix}0 & 0 & 0 & 1 \\ 0 & 0 & 1 & 0 \\ 0 & 0 & 0 & 0 \\ 0 & 0 & 0 & 0\end{matrix} ] - [ \begin{matrix}0 & 0 & 0 & 1 \\ 0 & 0 & 0 & 0 \\ 0 & 0 & 0 & 0 \\ 0 & 0 & 0 & 0\end{matrix} ] \\ = [ \begin{matrix}0 & 1 & 0 & 0 \\ 0 & 0 & 1 & 0 \\ 0 & 0 & 0 & 1 \\ 0 & 0 & 0 & 0\end{matrix} ]\end{matrix}$$

where composite gates of dimension 4×4 involving Pauli and singleton ladder operators of size 2×2 represented as

$${G}_{4}^{{s}_{o} {l}_{L}} := {σ}_{0} ⊗ {l}_{L} = [ \begin{matrix}0 & 1 & 0 & 0 \\ 0 & 0 & 0 & 0 \\ 0 & 0 & 0 & 1 \\ 0 & 0 & 0 & 0\end{matrix} ] ,$$

$${G}_{4}^{{s}_{1} {l}_{L}} = {l}_{L} ⊗ {σ}_{x} = [ \begin{matrix}0 & 0 & 0 & 1 \\ 0 & 0 & 1 & 0 \\ 0 & 0 & 0 & 0 \\ 0 & 0 & 0 & 0\end{matrix} ] , and$$

$${G}_{4}^{{l}_{L} {l}_{L}} := {l}_{L} ⊗ {l}_{L} = [ \begin{matrix}0 & 0 & 0 & 1 \\ 0 & 0 & 0 & 0 \\ 0 & 0 & 0 & 0 \\ 0 & 0 & 0 & 0\end{matrix} ]$$

whereby, elementary 2×2 quantum Pauli operators represented as,

$${σ}_{1} ( o r , {σ}_{x} ) := [ \begin{matrix}0 & 1 \\ 1 & 0\end{matrix} ]$$

$${σ}_{2} ( o r , {σ}_{y} ) := [ \begin{matrix}0 & - i \\ i & 0\end{matrix} ]$$

$${σ}_{3} ( o r , {σ}_{z} ) := [ \begin{matrix}1 & 0 \\ 0 & - 1\end{matrix} ] ;$$

and elementary singleton ladder operators represented as

$${l}_{L} = \frac{1}{2} ( {σ}_{x} + i {σ}_{y} ) = [ \begin{matrix}0 & 1 \\ 0 & 0\end{matrix} ]$$

$${l}_{R} = \frac{1}{2} ( {σ}_{x} - i {σ}_{y} ) = [ \begin{matrix}0 & 0 \\ 1 & 0\end{matrix} ] ,$$

here, I_{L}, and I_{R} are lowering ladder operator and raising ladder operator respectively.

In a preferred embodiment of the present quantum elementary gate-based composite system, the quantum circuit for the Canonical form based 4×4 Jordan system involving the elementary Pauli operators and singleton ladder operators includes

input sub-system (101-104 ) for inputting digits (0/1) for the 2×2 subsequent quantum gates;

quantum subsystem having a 2×2 Pauli-X quantum gate (105), singleton operators (106, 107) and a Pauli-Y quantum gate (108);

tensor sub-system having tensor operator blocks (109-111) to perform tensor operations among the inputs and generate output.

In a preferred embodiment of the present quantum elementary gate-based composite system, the tensor operator blocks (109-111) includes

a first tensor operator block (109) to perform the tensor operation between Pauli-X gate (105) and singleton operator (106);

a second tensor block (110) to perform the tensor operation between two singleton operators (106, 107); and

a third tensor operator block (111) to perform the tensor operation between the singleton operator (107) and the Pauli-Y gate (108).

In a preferred embodiment of the present quantum elementary gate-based composite system, the quantum circuit further includes

an adder circuit (112) to adds output of the tensor product from the first and the second tensor blocks (109) and (111); and

a subtractor block (113) to receive output of the adder block (112) in positive input port, and output of the second tensor block (110) in negative input port, wherein output of the subtractor block (113) produces the 4×4 Jordan-form quantum composite gate J₄.

In a preferred embodiment of the present quantum elementary gate-based composite system, the Jordan-form quantum composite gate J₄ is configured to realize Toeplitz-structured matrix of dimension 4×4 as

$${T}_{4} = ( t [ 0 ] \times {I}_{4} ) + ( t [ - 1 ] \times {J}_{4} ) + ( t [ - 2 ] \times {J}_{4}^{2} ) + ( t [ - 3 ] \times {J}_{4}^{3} ) + ( t [ 1 ] \times {K}_{4} ) + ( t [ 2 ] \times {K}_{4}^{2} ) + ( t [ 3 ] \times {K}_{4}^{3} ) \qquad ( 2 )$$

$$[ \begin{matrix}t [ 0 ] & t [ - 1 ] & t [ - 2 ] & t [ - 3 ] \\ t [ 1 ] & t [ 0 ] & t [ - 1 ] & t [ - 2 ] \\ t [ 2 ] & t [ 1 ] & t [ 0 ] & t [ - 1 ] \\ t [ 3 ] & t [ 3 ] & t [ 1 ] & t [ 0 ]\end{matrix} ] , \qquad ( 3 )$$

$$where$$

$${J}_{4} = [ \begin{matrix}0 & 1 & 0 & 0 \\ 0 & 0 & 1 & 0 \\ 0 & 0 & 0 & 1 \\ 0 & 0 & 0 & 0\end{matrix} ] , {J}_{4}^{2} = [ \begin{matrix}0 & 0 & 1 & 0 \\ 0 & 0 & 0 & 1 \\ 0 & 0 & 0 & 0 \\ 0 & 0 & 0 & 0\end{matrix} ] , {J}_{4}^{3} = [ \begin{matrix}0 & 0 & 0 & 1 \\ 0 & 0 & 0 & 0 \\ 0 & 0 & 0 & 0 \\ 0 & 0 & 0 & 0\end{matrix} ]$$

here, K₄ is the complex conjugate form of J₄ gates.

In a preferred embodiment of the present quantum elementary gate-based composite system, the Toeplitz matrix applicable for wireless communications including wireless channel (such as ISI channel), sensor array, radar etc. represented through sparse representation using the Jordan canonical structure facilitates the Toeplitz system representation and effective Hamiltonian simulation for complexity efficient spectrum estimation.

According to another aspect in the present invention there is provided a method for effective Hamiltonian simulation for the Toeplitz matrix represented through sparse representation using the Jordan canonical structure involving the above quantum elementary gate-based composite system comprising the steps of

initialization including setting number of the qubits (N_{q}), evolution time (τ) for the Hamiltonian simulation, matrix dimension (N) of the Toeplitz system, Toeplitz-symbols (t₀, t₁, . . . , t_{N}), the target precision ϵ_{T} for the Hamiltonian simulation, and order of approximation (L) of Taylor series;

symmetric Toeplitz formation using the quantum Jordan gates, wherein identity operators can be used to form a symmetric Toeplitz matrix as

$${T}_{N} = {t}_{0} {I}_{N} + {Σ}_{n = 1}^{N} {t}_{n} ( {J}_{N}^{n} + {K}_{N}^{n} ) ;$$

performing Hamiltonian simulation involving Taylor series approximation up to order L to maintain a precision ϵ_{T} for the approximation, wherein the Hamiltonian simulation is performed as follows

∥U− [symbol] ∥≤ϵ_{T}, where [symbol] ≈e^{-iT}^{_{N}}^{τ}.

quantum eigenvalue estimation involving multiple-quantum phase estimation (QPE) technique by selectively using sub-processing steps which are eigen-state initialization, superposition of ancillary qubits, controlled-U rotations, and inverse quantum Fourier transform (IQFT);

storing estimated spectrum on a QRAM after the quantum measurement of ancillary qubits on basis vectors which give the estimated eigenvalues.

A system for efficient spectrum estimation of the Toeplitz-structured system designed using quantum Jordan gates involving the quantum elementary gate-based composite system as referred hereinbefore comprises

a Toeplitz data-sampler (301) for storing input Toeplitz symbols on a quantum register and sending the entries to multipliers (304, 305) sequentially to process further;

said multiplier (305) for multiplying first data entry t(0) with identity operator generated by block (302), whereby rest entries are sequentially processed and multiplied with Jordan gates produced by block (303) using the multiplier (304);

adder (306) to add outputs of the multipliers (304, 305) for processing as a Toeplitz-structured Hamiltonian (307);

Hamiltonian simulator (308) for performing quantum simulation for generating approximate unitary operator [symbol] _{N};

quantum phase estimator block (310), together with an oracle (309) for performing quantum phase estimations involving sub-systems such as state initializer (310-1), Hadamard operators (310-b), control-U rotations block (310-c), IQFT-circuit (310-d), and quantum measurement (310-e), wherein the estimated spectrum is stored on a quantum register (311).

### BRIEF DESCRIPTION OF THE ACCOMPANYING DRAWINGS

FIG. 1 shows 4×4 Jordan-form composite quantum gate using Pauli and Singleton Ladder gates.

FIG. 2 shows quantum spectrum estimation technique for Jordan-gate based Toeplitz System in accordance with a preferred embodiment of the present invention.

FIG. 3 shows system representation for spectrum estimation of a Toeplitz system using composite Jordan gates in accordance with a preferred embodiment of the present invention.

FIG. 4a shows 4×4 symmetric Jordan-gate in accordance with a preferred embodiment of the present invention.

FIG. 4b shows system implementation of 4×4 Toeplitz matrix using proposed Jordan and symmetric Jordan gates in accordance with a preferred embodiment of the present invention.

FIG. 5 shows a comparison of Jordan gate-based Toeplitz-structured Hamiltonian simulation with standard Hamiltonian simulation complexity.

FIG. 6 shows comparison of estimated spectrum of a Toeplitz structured Matrix of size 8×8 for different quantum time resolution.

FIG. 7 shows a receiver array front-end with ULA of sensor size M, and sensing incident rays from P objects in accordance with an application of a preferred embodiment of the present invention.

FIG. 8 shows probability of error (Pₑ) with SNR in accordance with the present invention.

### DETAILED DESCRIPTION OF THE INVENTION WITH REFERENCE TO THE ACCOMPANYING DRAWINGS

As stated hereinbefore, the disclosed system design according to the present invention corresponds to a new quantum circuit system or a quantum elementary gate-based composite system. It is closely related to the broad area of quantum technology, specifically quantum signal processing and quantum computation. The proposed system is a quantum realization of Jordan-form based systems whose diagonals are zero (0) and super-diagonals are one (1). It is implemented using Pauli operators (specifically, Pauli-X, and Pauli-Y operators), and singleton ladder operator which are implementable in a conventional quantum photonics circuit. The proposed quantum system has potential to represent large matrices in near-term quantum science and technology (QST). As QST is expected to serve as an umbrella technology for solving large-scale engineering and industrial problems in the near future, the proposed design can be a fundamental quantum circuit to be embedded.

Jordan decomposition-based representation is often used in sparse, and low-rank systems as an efficient representation. The present work targets Jordan canonical form corresponding to zero-eigenvalue of a matrix, whose quantum circuit is introduced in this invention. Quantum Jordan block can be used as a quantum-gate in near future for simulating large matrices, specially structured matrices such as symmetric, and Toeplitz matrix. In this work, elementary quantum gates such as Pauli operators and singleton ladder operator have been used to design the quantum Jordan-form system.

### Operative Sequences for a 4×4 Jordan Matrix Decomposition With Quantum Gates:

The Jordan Canonical form corresponding to the zero-eigenvalue of some matrix can be written as follows

$$\begin{matrix}{J}_{4} ; = ( + 1 ) {G}_{4}^{{s}_{o} {l}_{L}} + ( + 1 ) {G}_{4}^{{s}_{1} {l}_{L}} + ( - 1 ) {G}_{4}^{{l}_{L} {l}_{L}} \\ = [ \begin{matrix}0 & 1 & 0 & 0 \\ 0 & 0 & 0 & 0 \\ 0 & 0 & 0 & 1 \\ 0 & 0 & 0 & 0\end{matrix} ] + [ \begin{matrix}0 & 0 & 0 & 1 \\ 0 & 0 & 1 & 0 \\ 0 & 0 & 0 & 0 \\ 0 & 0 & 0 & 0\end{matrix} ] - [ \begin{matrix}0 & 0 & 0 & 1 \\ 0 & 0 & 0 & 0 \\ 0 & 0 & 0 & 0 \\ 0 & 0 & 0 & 0\end{matrix} ] \\ = [ \begin{matrix}0 & 1 & 0 & 0 \\ 0 & 0 & 1 & 0 \\ 0 & 0 & 0 & 1 \\ 0 & 0 & 0 & 0\end{matrix} ]\end{matrix} \qquad ( 1 )$$

Here, the composite gates (of dimension 4×4) made with Pauli and single-ton ladder operators of size 2×2 are given as follows-

$${G}_{4}^{{s}_{o} {l}_{L}} := {σ}_{0} ⊗ {l}_{L} = [ \begin{matrix}0 & 1 & 0 & 0 \\ 0 & 0 & 0 & 0 \\ 0 & 0 & 0 & 1 \\ 0 & 0 & 0 & 0\end{matrix} ] ,$$

$${G}_{4}^{{s}_{1} {l}_{L}} = {l}_{L} ⊗ {σ}_{x} = [ \begin{matrix}0 & 0 & 0 & 1 \\ 0 & 0 & 1 & 0 \\ 0 & 0 & 0 & 0 \\ 0 & 0 & 0 & 0\end{matrix} ] , and$$

$${G}_{4}^{{l}_{L} {l}_{L}} := {l}_{L} ⊗ {l}_{L} = [ \begin{matrix}0 & 0 & 0 & 1 \\ 0 & 0 & 0 & 0 \\ 0 & 0 & 0 & 0 \\ 0 & 0 & 0 & 0\end{matrix} ]$$

Here, the elementary 2×2 quantum Pauli operators can be written as follows

$$\begin{matrix}{σ}_{1} ( o r , {σ}_{x} ) := [ \begin{matrix}0 & 1 \\ 1 & 0\end{matrix} ] \\ {σ}_{2} ( o r , {σ}_{y} ) := [ \begin{matrix}0 & - i \\ i & 0\end{matrix} ] \\ {σ}_{3} ( o r , {σ}_{z} ) := [ \begin{matrix}1 & 0 \\ 0 & - 1\end{matrix} ]\end{matrix}$$

There are two basic singleton ladder operators (which can be derived from the Pauli-gates as well) given by

$${l}_{L} ; = \frac{1}{2} ( {σ}_{x} + i {σ}_{y} ) = [ \begin{matrix}0 & 1 \\ 0 & 0\end{matrix} ]$$

$${l}_{R} ; = \frac{1}{2} ( {σ}_{x} - i {σ}_{y} ) = [ \begin{matrix}0 & 0 \\ 1 & 0\end{matrix} ]$$

Here, I_{L}, and I_{R} are called lowering ladder operator, and raising ladder operator respectively.

The system can also be augmented for higher dimensional architecture which is discussed as follows.

### Generalization of the Architecture for Jordon Matrix N>4 Case:

For implementing large systems (with N>4), we require the system size N to be a power of 2 for efficient implementation of a quantum circuit using minimum number of qubits. Tensor product of the above operators can be realized as below

G₄Xⁱ₂⊗X^{j}₂

where G4∈ R^{4×4}, Xⁱ₂ and X^{j}₂ are two arbitrary quantum operators of size 2×2 such as the Pauli-gates and/or singleton operators. Using tensor-products, we can further implement augmented operators with higher dimensions (as a power of 2) given by

$${G}_{{2}^{n}}^{{C}_{1} {C}_{2}} = {G}_{{2}^{\frac{n}{2}}}^{{C}_{1}} ⊗ {G}_{{2}^{\frac{n}{2}}}^{{C}_{2}} = {G}_{{2}^{k}}^{{C}_{1}} ⊗ {G}_{{2}^{n - k}}^{{C}_{1}} ∀ k ∈ ℤ$$

where G^{C1-C2} is an augmented operator of dimension N=2ⁿ, which is a tensor product of two smaller dimensional operators G^{C1} and G^{C2}. For example, the operators I₈, and I₁₆ can be implemented as I₈=I₂⊗I₄ and I₁₆=I₄⊗I₄ respectively. Here, I_{N} is the identity gate of dimension N.

### Proposed Quantum Architecture For a 4×4 Jordan-Matrix As An Example

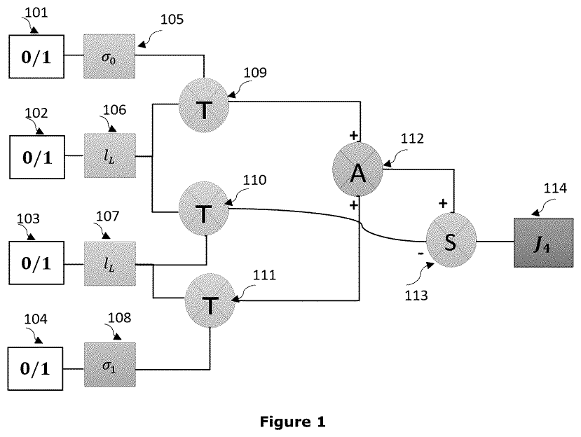

The present invention proposes a generalized realization of the Jordan form using the Pauli and Singleton Ladder gates. However, for simplicity, the proposed Quantum circuit for a 4×4 Jordan system is shown in FIG. 1.

A brief description of FIG. 1: In FIG. 1, the composite quantum gate comprises of Pauli gates (shown in green) and ladder gates (shown in orange) as the elementary quantum gates. The sub-systems (101-104) denote the input digits (0/1) for the 2×2 subsequent gates. Here, the quantum subsystem (105) denotes a 2×2 Pauli-X quantum gate, (106), and (107) represent the lowering ladder singleton operators (in short ladder operators), and (108) denote the Pauli-Y quantum gate.

The sub-system (109-111) are the tensor operator blocks, which perform the tensor operations among the inputs and generate the output. The tensor operator block (109) performs the tensor operation between Pauli-X gate (105) and ladder gate (106), and the block (111) performs the tensor operation between ladder gate (107), and Pauli-Y gate (108). The tensor block (110) performs the tensor operation between two ladder gates (107) and (108). The operator (112) is an adder circuit which adds the output of tensor product from (109) and (111) sub-systems. The output of the adder block (112) is fed to the subtractor block (113) in positive input port, and the output from (110) quantum sub-system is fed as negative input of (113) block. The output of the (113) block produces the 4×4 Jordan-form quantum composite gate J₄.

### A Toeplitz Matrix Representation Using Proposed Jordan Gates For 4×4 System:

The present work demonstrates the application of Jordan matrix. Take the example of a Toeplitz-structured system of dimension 4×4. It can be realized using the J₄ composite quantum gates as follows

$${T}_{4} = ( t [ 0 ] \times {I}_{4} ) + ( t [ - 1 ] \times {J}_{4} ) + ( t [ - 2 ] \times {J}_{4}^{2} ) + ( t [ - 3 ] \times {J}_{4}^{3} ) + ( t [ 1 ] \times {K}_{4} ) + ( t [ 2 ] \times {K}_{4}^{2} ) + ( t [ 3 ] \times {K}_{4}^{3} ) \qquad ( 2 )$$

$$[ \begin{matrix}t [ 0 ] & t [ - 1 ] & t [ - 2 ] & t [ - 3 ] \\ t [ 1 ] & t [ 0 ] & t [ - 1 ] & t [ - 2 ] \\ t [ 2 ] & t [ 1 ] & t [ 0 ] & t [ - 1 ] \\ t [ 3 ] & t [ 3 ] & t [ 1 ] & t [ 0 ]\end{matrix} ] \qquad ( 3 )$$

$$where ,$$

$${J}_{4 =} [ \begin{matrix}0 & 1 & 0 & 0 \\ 0 & 0 & 1 & 0 \\ 0 & 0 & 0 & 1 \\ 0 & 0 & 0 & 0\end{matrix} ] , {J}_{4}^{2} = [ \begin{matrix}0 & 0 & 1 & 0 \\ 0 & 0 & 0 & 1 \\ 0 & 0 & 0 & 0 \\ 0 & 0 & 0 & 0\end{matrix} ] , {J}_{4}^{3} = [ \begin{matrix}0 & 0 & 0 & 1 \\ 0 & 0 & 0 & 0 \\ 0 & 0 & 0 & 0 \\ 0 & 0 & 0 & 0\end{matrix} ]$$

Here, the K₄ is the complex conjugate form of J₄ gates. In this work 8 quantum gates are used to represent a non-symmetric 4×4 Toeplitz matrix. The gate can be red3uced to only 4 Jordan gates and one identity gates to represent a symmetric 4×4 Toeplitz matrix.

### Quantum Spectrum Estimation of a Symmetric Toeplitz Matrix Using Composite Jordan Gates:

Toeplitz systems are observed in many practical settings, especially in wireless communications including wireless channel (such as ISI channel), sensor array, radar etc. In such applications, one of the central goals is to know the spectrum of a Toeplitz matrix. There have some classical approaches for the spectrum estimation depending on practical systems and its constraints (e.g., sample size, noise variance and its probability density function, sensor array size, and available bandwidth). However, the classical approaches are computationally inefficient for large-scale applications.

Quantum spectrum estimation helps in estimating the eigenvalues of a Hamiltonian (a Hermitian matrix) with much lesser complexity while simulated on a quantum computer. However, the standard Hamiltonian simulation does not address the structural advantage of a Toeplitz system. In this invention it is shown that, a Toeplitz matrix can be represented in an interesting way through sparse representation using Jordan canonical structure. However, at the present state of art, such gates do not exist.

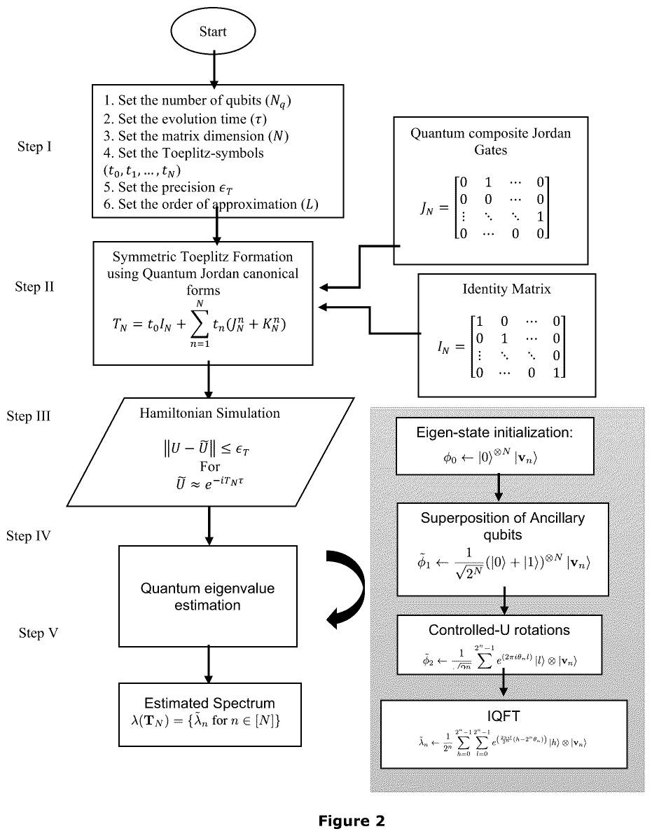

In this work, a novel design of a composite Jordan system using elementary quantum gates is shown. This work also shows how this design helps in Toeplitz system representation and effective Hamiltonian simulation for the complexity efficient spectrum estimation. The proposed method is illustrated in FIG. 2. The description of the algorithmic flow chart is shown as follows.

Step I: Initialization: Set the number of qubits (N_{q}), evolution time (τ) for the Hamiltonian simulation, matrix dimension (N) of the Toeplitz system, Toeplitz-symbols (t₀, t₁, . . . , t_{N}), the target precision ϵ_{T} for the Hamiltonian simulation, and order of approximation (L) of Taylor series.

Step II: Symmetric Toeplitz formation using Quantum Jordan gates: Quantum composite Jordan gates (as shown in FIG. 1) and the identity operators can be used to form a symmetric Toeplitz matrix as

$${T}_{N} = {t}_{0} {I}_{N} + {Σ}_{n = 1}^{N} {t}_{n} ( {J}_{N}^{n} + {K}_{N}^{n} ) . \qquad ( 4 )$$

Step III: Hamiltonian simulation: Hamiltonian simulation needs to be performed for Toeplitz-structured Hamiltonian T_{N}. Here, Taylor series approximation up to order L is used to maintain a precision ϵ_{T} for the approximation. The Hamiltonian simulation can be done as follows

∥U− [symbol] ∥≤ϵ_{T}, where [symbol] ≈e^{-iT}^{_{N}}^{τ}. (5)

Step IV: Quantum eigenvalue estimation: Here, multiple-quantum phase estimation (QPE) technique is used to estimate the eigenvalues of the Toeplitz system. It has several sub-processing blocks which are eigen-state initialization, superposition of ancillary qubits, controlled-U rotations, and inverse quantum Fourier transform (IQFT).

Step V: Estimated spectrum: The estimated spectrum can be stored on a QRAM efficiently after the quantum measurement of ancillary qubits on basis vectors which give the estimated eigenvalues.

### Description of the System Model

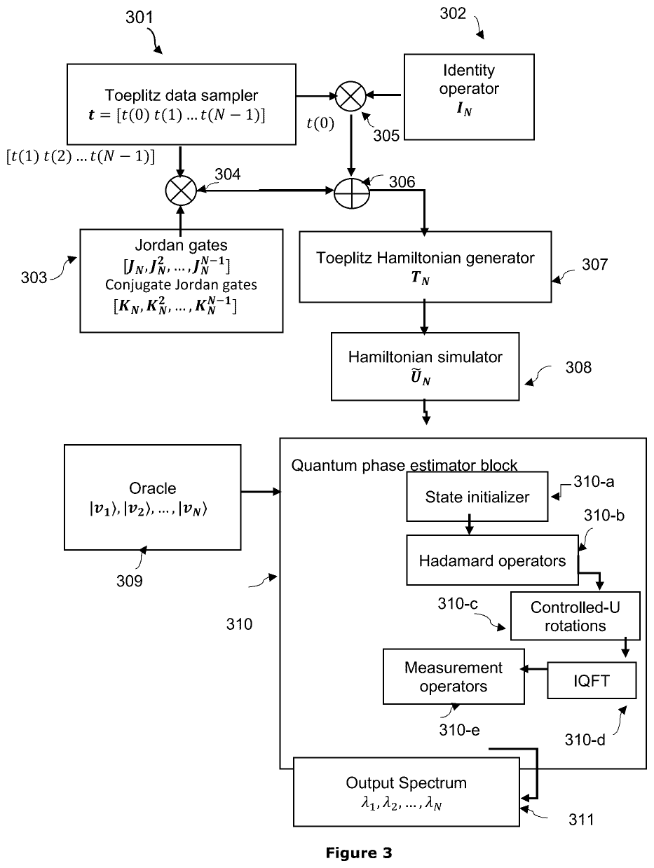

The block level description of the efficient spectrum estimation algorithm of a Toeplitz-structured system (designed using quantum Jordan gates) is shown in FIG. 3. A Toeplitz data-sampler (301) stores the input Toeplitz symbols on a quantum register. The data sampler sends the entries sequentially to process further. The first data entry t(0) is multiplied with identity operator generated by the block (302) using the multiplier (305). The rest entries are sequentially processed and multiplied with Jordan gates produced by (303) using the multiplier (304), following the algorithm as discussed in FIG. 2. The output of (304) and (305) are added by (306) adder block. It is processed as a Toeplitz-structured Hamiltonian as shown in (307). The Hamiltonian simulator (308) performs the quantum simulation for generating the approximate unitary operator [symbol] _{N}. Quantum phase estimator block (310), together with an oracle (309) perform quantum phase estimations using several sub-systems such as state initializer (310-1), Hadamard operators (310-b), control-U rotations block (310-c), IQFT-circuit (310-d), and quantum measurement (310-e). The estimated spectrum can be stored on a quantum register as shown in block (311).

### Results and Discussion:

Using the Taylor series approximation, the standard Hamiltonian simulation possesses a complexity given by

$$𝕆 ( \frac{{n}_{q} {log}^{2} ( \frac{{s}^{2} ‖ {T}_{N} ‖ {max}^{τ}}{{ϵ}_{T}} )}{log log ( \frac{{s}^{2} ‖ {T}_{N} ‖ {max}^{τ}}{{ϵ}_{T}} )} )$$

Here, n_{q} denotes the number of qubits taken to represent the quantum state vectors (which determines the precision in measurement), s is the sparsity of the system. Here, in this work a dense Toeplitz matrix is considered for which s may equal N. The simulation time is denoted by τ. For sub-optimal choice of τ, phase estimator error will be incurred. A term called quantum time resolution (QTR) is defined, which is the amount of time to simulate a quantum system.

The proposed Jordan gate-based Toeplitz system incur a reduced complexity given by

$$𝕆 ( \frac{{n}_{q} {log}^{2} ( k \frac{τ}{{ϵ}_{T}} )}{log log ( k \frac{τ}{{ϵ}_{T}} )} )$$

Here, using the Quantum Jordan operators, the Toeplitz matrix T_{N} can be represented as a combination of sparse matrices (with sparsity s=2), which is obtained as a structural advantage. Here, the parameter k is a constant, and it is assumed that

$$k \frac{τ}{{ϵ}_{T}} \approx 4 .$$

The precision of the Hamiltonian simulation is taken as ϵ_{T}=10⁻³.

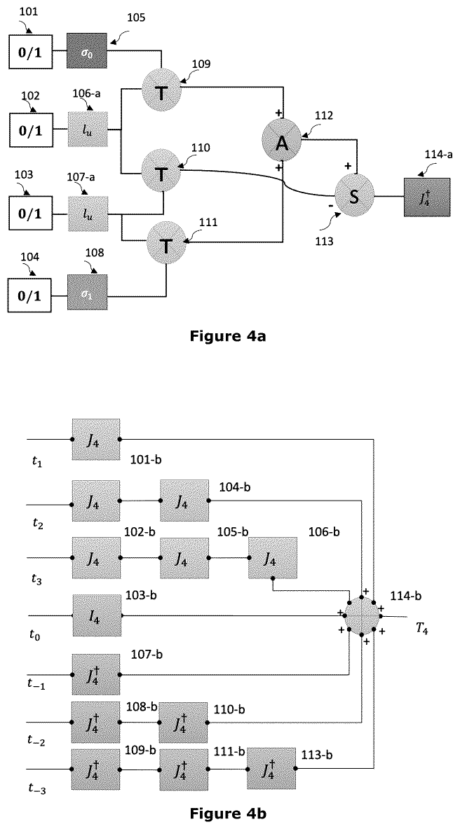

For the implementation of a 4×4 Toeplitz matrix, a symmetric Jordan gate (J₄^{†}) is required. Design for a 4×4 symmetric Jordan-gate using elementary quantum gates is shown in FIG. 4a. In this design, the upper ladder operators lᵤ (unit 106-a, and unit 107-a) instead lower ladder gates is used (used as unit 106 and unit 107 in FIG. 1) to get the symmetric Jordan Gate (J₄^{†}). Note that, Previously, we named this gate as K during the implementation of the Toeplitz matrix given in (3).

A hardware implementation of the Toeplitz system using the J₄ and J₄^{†}composite gates is shown in FIG. 4b. The FIG. 4b shows a system implementation of 4×4 Toeplitz matrix using proposed Jordan and symmetric Jordan gates. Here, the Toeplitz matrix generating symbols are denoted by [t| |−3, t₋₂, t₋₁, t₀, t₁, t₂, t₃] which are the input to the Toeplitz matrix generating system. The first row of the Toeplitz matrix is[t| |0, t₁, t₂, t₃] and the first column is given by [t| |0, t₋₁, t₋₂, t₃]^{T} respectively for this system. For the symmetric system, row vector and column vector have same elements, i.e., every t₋ᵢ=tᵢ for i=1, . . . , 4. In this figure, sub-system 101-b to 106-b are the Jordan systems (as disclosed in FIG. 1), and the sub-system 107-b to 113-b denote the symmetric Jordan gates (as disclosed in FIG. 1.1). The unit 114-b is an adder operator which has multiple inputs and one output. The sub-system I₄ as shown in 103-b is the identity operator (of size 4×4). The output of the circuit is the realization of the Toeplitz matrix T₄. Here, we have used 6 Jordan gates, 6 symmetric Jordan gates, and one identity gate for the implementation of the 4×4 Toeplitz matrix.

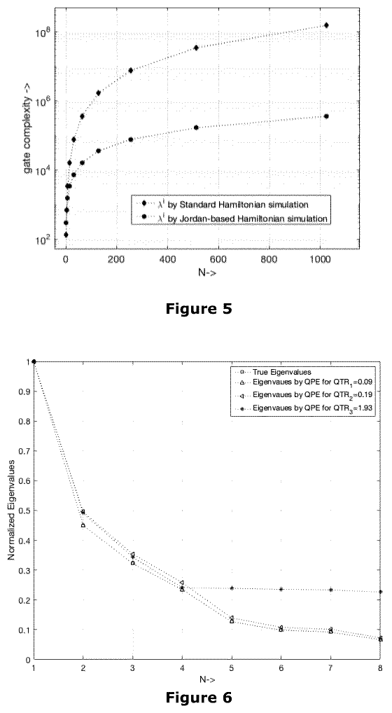

An empirical simulation of the structured Hamiltonian simulation in comparison with standard Hamiltonian simulation is shown in FIG. 5. For different values of QTR (when an optimal value is unknown), a comparison of estimated eigenvalues is shown in FIG. 6.

As, the size of the Toeplitz-Hamiltonian is increased, the gate complexity of the structured Hamiltonian simulation shows excellent complexity advantage as compared to the standard Hamiltonian simulation (FIG. 5).

An optimal choice of QTR is often unknown for the Hamiltonian simulation. A plot for different values of the QTR may be considered to show how the estimated eigenvalues differ from the true eigenvalues for a 8×8 Toeplitz matrix. It shows that as the simulation time chosen lesser, better is the estimate. Generally, it should be as less as possible based on the available quantum resources.

Advantages of the present invention can be summarized hereunder:
The proposed quantum circuit has low computational complexity as the Jordan-form system designed here is a sparse-system representation whose super-diagonals are 1 and rest elements are zero. Further, it is implemented with fundamental quantum gates such as Pauli operators, and singleton ladder operators, which are available quantum gates at the present state of art QST.
The disclosed quantum composite gate of Jordan-form system can represent a N×N dimensional Toeplitz-structured and Hermitian matrix with only N composite Jordan gates, which is excellent in simulating large-dimensional (for example, N>16) systems such as signal processing and wireless communication systems.

Using the composite Jordan-form system, the eigenvalue-spectrum for low-rank and sparse matrices (which has a zero eigenvalue) can be easily generated (through Hamiltonian simulation and phase estimation) with the proposed architecture with much lesser computational operations, which will provide fast, and energy-efficient data and signal processing in the near-term QST algorithms and systems.

### Application in Array Signal Processing:

Toeplitz matrix are widely used in array processing applications. Here, the application of the proposed quantum system to antenna array signal processing as follows.

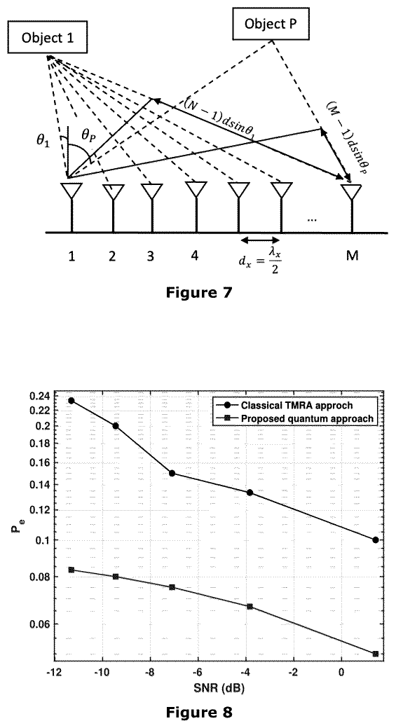

FIG. 7 shows that P narrow-band far-field signals impinge on uniform linear array (ULA) with M(M>P) antennas from the directions of θ={θₚ} simultaneously at time t.

The received signal vector at the antenna receiver can be modelled as

y(t)=Ax(t)+w(t),

Where x(t) is the incoming signal vector length P, and w(t) is the additive white Gaussian noise vector which perturb the received signal. The matrix A is called steering manifold matrix. The matrix AV andermonde structure with the consecutive columns are the function of incident angles (in order), denoted by A(θ)=[α(θ₁), . . . , α(θₚ)].The source (incoming) signals and noise vector are assumed to be uncorrelated and given by

E(x(t₁)x(t₂)^{†})=Diag(σₓ²)δₜ_{₁}_{,t}_{₂}

E(ν(t₁)ν(t₂)^{†})=σ_{ν}²Iδₜ_{₁}_{,t}_{_{2′}}

where Diag(σₓ²) represents a diagonal matrix with the vector σₓ²=[σ₁², . . . , σₚ²] which denote the power of the source signals. Here, δₜ_{₁}_{,t}_{₂} denotes the Dirac delta function which has a value of 1 for t₁=t₂, and 0 elsewhere. The noise vector has zero mean and variance of σ_{ν}² in our case. The covariance matrix of the received signal vector is given

$${T}_{y} = E ( y ( t ) {y ( t )}^{†} )$$

$${\sum }_{i = 1}^{P} {σ}_{i}^{2} a ( {θ}_{i} ) {a ( {θ}_{i} )}^{†} + {σ}_{v}^{2} I = {T}_{x} + {σ}_{v}^{2} I .$$

The matrix Tₓ,∧ T_{y} are symmetric (or Hermitian) Toeplitz matrices of the source and received signal respectively. We take multiple snapshots (here, L snapshots) to take average of the received signal as follows

$${\hat{T}}_{y} = {\sum }_{j = 1}^{L} y ( {t}_{j} ) {y ( {t}_{j} )}^{†} .$$

The spectrum estimation method for the matrix [symbol] follows FIG. 2 and its hardware realisation in FIG. 3. For simulation results in this application, the below table is referred.

TABLE 1
Simulation parameters

| Parameters | Numerical value |
|---|---|
| Antenna Size (M) | 16 |
| Number of objects (P) | 10 |
| Incident angle (θ) | $𝒰 ( - \frac{π}{2} , \frac{π}{2} )$ |
| Signal Power (σₓ²) | 0.5 Watt |
| Wavelength (λₓ) | 3.7 mm (at frequency 80 GHz) |
| Noise standard deviation (σᵥ) | 0.01 |
| Number of iteration (N) | 5000 |
| QTR (τ) | 0.48 for η = 2 |

A simulation framework with sensor (antenna) size of M=16 uniformly distributed with distance between elements be λ/2 with λ=3.7 mm is used considering a transmission frequency of 80 GHz. The signal power is fixed to 0.5 watt for a sinusoidal signal, and the standard deviation of the Gaussian additive noise to be 0.01. P=10-objects are taken in front of the receiver whose angular positions θ can be uniformly distributed within

$$( \frac{- π}{2} , \frac{π}{2} ) .$$

With L=5000 simulations to take an estimate of the Hermitian Toeplitz matrix [symbol] for the TMRA problem in present setting. It is found that the ι/2-norm of the estimated matrix is approximately | [symbol] ∥₂=1.0087. The matrix [symbol] , we take quantum time resolution (QTR) or simulation time of 0.48 second with preparing the unitary operator e⁽⁻ⁱ [symbol] ^{t)}.

Following the steps as shown in FIG. 2, it is found that the eigenvalue spectrum of the matrix [symbol] . In this problem, present object is to detect the number of sources present in front of the receiver. On this, the estimated eigenvalues is compared with a detection threshold (following [4]) to detect the correct number of sources. The probability of error (Pₑ) is the ratio of missed-detected targets to the actual number of targets.

FIG. 8 shows a comparison plot for the Pₑ for source-detection problem in array processing using the proposed Quantum method (based on FIG. 2 with the proposed quantum architecture shown in FIGS. 1, 1.1, and 1.2) in comparison with classical Toeplitz matrix reconstruction approach (TMRA [1]). The error-probability Pₑ for the quantum approach is appeared to be sufficiently low as compared to the classical approach, obtained in the simulation. At a signal to noise ratio (SNR) of −11dB, Pₑ=0.08 for the quantum approach, and Pₑ=0.23 for the classical approach. It shows an improvement of the detection performance by 65.21% approximately using the quantum framework disclosed in the invention. In comparison with the classical TMRA approach, it is found that the error probability for the proposed quantum method is improved for the multi-object (source) detection problem in array signal processing.

1. A quantum elementary gate-based composite system, comprising:
elementary quantum gates including Pauli operators and Singleton ladder operators;
said Pauli operators and said Singleton ladder operators are operatively combined to form a Jordan Canonical form-based representation suitable for simulating large quantum matrices, specially structured matrices such as symmetric, and Toeplitz matrix.

2. The quantum elementary gate-based composite system as claimed in claim 1, wherein the Jordan Canonical form-based representation of size N×N for implementing large quantum matrices based systems with N>4 includes tensor operators for tensor product realizing
G₄Xⁱ₂⊗X^{j}₂
where G4∈ R^{4×4}, Xⁱ₂ and X^{j}₂ are two arbitrary quantum operators of size 2×2 such as the Pauli-gates and/or singleton operators;
wherein using tensor-products, augmented operators with higher dimensions (as a power of 2) is implemented by
$${G}_{{2}^{n}}^{{C}_{1} {C}_{2}} = {G}_{{2}^{\frac{n}{2}}}^{{C}_{1}} ⊗ {G}_{{2}^{\frac{n}{2}}}^{{C}_{2}} = {G}_{{2}^{k}}^{{C}_{1}} ⊗ {G}_{{2}^{n - k}}^{{C}_{1}} ∀ k ∈ ℤ$$
where G^{C1C2} is an augmented operator of dimension N=2n, which is a tensor product of two smaller dimensional operators G^{C1} and G^{C2}.

3. The quantum elementary gate-based composite system as claimed in claim 1, wherein the Jordan Canonical form-based representation of size 4×4 represented as:
$${J}_{4} ; = ( + 1 ) {G}_{4}^{{s}_{o} {l}_{L}} + ( + 1 ) {G}_{4}^{{s}_{1} {l}_{L}} + ( - 1 ) {G}_{4}^{{l}_{L} {l}_{L}} = [ \begin{matrix}0 & 1 & 0 & 0 \\ 0 & 0 & 0 & 0 \\ 0 & 0 & 0 & 1 \\ 0 & 0 & 0 & 0\end{matrix} ] + [ \begin{matrix}0 & 0 & 0 & 1 \\ 0 & 0 & 1 & 0 \\ 0 & 0 & 0 & 0 \\ 0 & 0 & 0 & 0\end{matrix} ] - [ \begin{matrix}0 & 0 & 0 & 1 \\ 0 & 0 & 0 & 0 \\ 0 & 0 & 0 & 0 \\ 0 & 0 & 0 & 0\end{matrix} ] = [ \begin{matrix}0 & 1 & 0 & 0 \\ 0 & 0 & 1 & 0 \\ 0 & 0 & 0 & 1 \\ 0 & 0 & 0 & 0\end{matrix} ]$$
where composite gates of dimension 4×4 involving Pauli and singleton ladder operators of size 2×2 represented as
$${G}_{4}^{{s}_{o} {1}_{L}} := {σ}_{0} ⊗ {l}_{L} = [ \begin{matrix}0 & 1 & 0 & 0 \\ 0 & 0 & 0 & 0 \\ 0 & 0 & 0 & 1 \\ 0 & 0 & 0 & 0\end{matrix} ] ,$$
$${G}_{4}^{{s}_{1} {l}_{L}} = {l}_{L} ⊗ {σ}_{x} = [ \begin{matrix}0 & 0 & 0 & 1 \\ 0 & 0 & 1 & 0 \\ 0 & 0 & 0 & 0 \\ 0 & 0 & 0 & 0\end{matrix} ] , and$$
$${G}_{4}^{{l}_{L} {l}_{L}} := {l}_{L} ⊗ {l}_{L} = [ \begin{matrix}0 & 0 & 0 & 1 \\ 0 & 0 & 0 & 0 \\ 0 & 0 & 0 & 0 \\ 0 & 0 & 0 & 0\end{matrix} ]$$
whereby, elementary 2×2 quantum Pauli operators represented as,
$${σ}_{1} ( or , {σ}_{x} ) := [ \begin{matrix}0 & 1 \\ 1 & 0\end{matrix} ]$$
$${σ}_{2} ( or , {σ}_{y} ) := [ \begin{matrix}0 & - i \\ i & 0\end{matrix} ]$$
$${σ}_{3} ( or , {σ}_{z} ) := [ \begin{matrix}1 & 0 \\ 0 & - 1\end{matrix} ] ;$$
and elementary singleton ladder operators represented as
$${l}_{L} = \frac{1}{2} ( {σ}_{x} + i {σ}_{y} ) = [ \begin{matrix}0 & 1 \\ 0 & 0\end{matrix} ]$$
$${l}_{R} = \frac{1}{2} ( {σ}_{x} - i {σ}_{y} ) = [ \begin{matrix}0 & 0 \\ 1 & 0\end{matrix} ] ,$$
here, I_{L}, and I_{R} are lowering ladder operator and raising ladder operator respectively.

4. The quantum elementary gate-based composite system as claimed in claim 3, wherein the quantum circuit for the Canonical form based 4×4 Jordan system involving the elementary Pauli operators and singleton ladder operators includes
input sub-system (101-104) for inputting digits (0/1) for the 2×2 subsequent quantum gates;
quantum subsystem having a 2×2 Pauli-X quantum gate(105), singleton operators (106, 107) and a Pauli-Y quantum gate (108);
tensor sub-system having tensor operator blocks (109-111) to perform tensor operations among the inputs and generate output.

5. The quantum elementary gate-based composite system as claimed in claim 4, wherein the tensor operator blocks (109-111) includes
a first tensor operator block (109) to perform the tensor operation between Pauli-X gate (105) and singleton operator (106);
a second tensor block (110) to perform the tensor operation between two singleton operators (106, 107); and
a third tensor operator block (111) to perform the tensor operation between the singleton operator (107) and the Pauli-Y gate (108).

6. The quantum elementary gate-based composite system as claimed in claim 4, wherein the quantum circuit further includes
an adder circuit (112) to adds output of the tensor product from the first and the second tensor blocks (109) and (111); and
a subtractor block (113) to receive output of the adder block (112) in positive input port, and output of the second tensor block (110) in negative input port, wherein output of the subtractor block (113) produces the 4×4 Jordan-form quantum composite gate J₄.

7. The quantum elementary gate-based composite system as claimed in claim 1, wherein the Jordan-form quantum composite gate J₄ is configured to realize Toeplitz-structured matrix of dimension 4×4 as
$${T}_{4} = ( t [ 0 ] \times {I}_{4} ) + ( t [ - 1 ] \times {J}_{4} ) + ( t [ - 2 ] \times {J}_{4}^{2} ) + ( t [ - 3 ] \times {J}_{4}^{3} ) + ( t [ 1 ] \times {K}_{4} ) + ( t [ 2 ] \times {K}_{4}^{2} ) + ( t [ 3 ] \times {K}_{4}^{3} ) \qquad ( 2 )$$
$$[ \begin{matrix}t [ 0 ] & t [ - 1 ] & t [ - 2 ] & t [ - 3 ] \\ t [ 1 ] & t [ 0 ] & t [ - 1 ] & t [ - 2 ] \\ t [ 2 ] & t [ 1 ] & t [ 0 ] & t [ - 1 ] \\ t [ 3 ] & t [ 3 ] & t [ 1 ] & t [ 0 ]\end{matrix} ] , \qquad ( 3 )$$
$$where$$
$${J}_{4 =} [ \begin{matrix}0 & 1 & 0 & 0 \\ 0 & 0 & 1 & 0 \\ 0 & 0 & 0 & 1 \\ 0 & 0 & 0 & 0\end{matrix} ] , {J}_{4}^{2} = [ \begin{matrix}0 & 0 & 1 & 0 \\ 0 & 0 & 0 & 1 \\ 0 & 0 & 0 & 0 \\ 0 & 0 & 0 & 0\end{matrix} ] , {J}_{4}^{3} = [ \begin{matrix}0 & 0 & 0 & 1 \\ 0 & 0 & 0 & 0 \\ 0 & 0 & 0 & 0 \\ 0 & 0 & 0 & 0\end{matrix} ]$$
here, K₄ is the complex conjugate form of J₄ gates.

8. The quantum elementary gate-based composite system as claimed in claim 1, wherein the Toeplitz matrix applicable for wireless communications including wireless channel (such as ISI channel), sensor array, radar etc. represented through sparse representation using the Jordan canonical structure facilitates the Toeplitz system representation and effective Hamiltonian simulation for complexity efficient spectrum estimation.

9. A method for effective Hamiltonian simulation for the Toeplitz matrix represented through sparse representation using the Jordan canonical structure involving the quantum elementary gate-based composite system as claimed claim 1, comprising:
initialization, including setting number of the qubits (N_{q}), evolution time (τ) for the Hamiltonian simulation, matrix dimension (N) of the Toeplitz system, Toeplitz-symbols (t₀, t₁, . . . , t_{N}), the target precision ϵ_{T} for the Hamiltonian simulation, and order of approximation (L) of Taylor series;
symmetric Toeplitz formation, using the quantum Jordan gates, wherein identity operators can be used to form a symmetric Toeplitz matrix as
$${T}_{N} = {t}_{0} {I}_{N} + {Σ}_{n = 1}^{N} {t}_{n} ( {J}_{N}^{n} + {K}_{N}^{n} ) ;$$
performing Hamiltonian simulation, involving Taylor series approximation up to order L to maintain a precision ϵ_{T} for the approximation, wherein the Hamiltonian simulation is performed as follows
∥U− [symbol] ∥≤ϵ_{T}, where [symbol] ≈e^{-iT}^{_{N}}^{τ},
quantum eigenvalue estimation involving multiple-quantum phase estimation (QPE) technique by selectively using sub-processing steps which are eigen-state initialization, superposition of ancillary qubits, controlled-U rotations, and inverse quantum Fourier transform (IQFT);
storing estimated spectrum on a QRAM after the quantum measurement of ancillary qubits on basis vectors which give the estimated eigenvalues.

10. A system for efficient spectrum estimation of the Toeplitz-structured system designed using quantum Jordan gates involving the quantum elementary gate-based composite system as claimed in claim 1, comprising:
a Toeplitz data-sampler (301) for storing input Toeplitz symbols on a quantum register and sending the entries to multipliers (304, 305) sequentially to process further;
said multiplier (305) for multiplying first data entry t(0) with identity operator generated by block (302), whereby rest entries are sequentially processed and multiplied with Jordan gates produced by block (303) using the multiplier (304);
adder (306) to add outputs of the multipliers (304, 305) for processing as a Toeplitz-structured Hamiltonian (307);
Hamiltonian simulator (308) for performing quantum simulation for generating approximate unitary operator [symbol] _{N};
quantum phase estimator block (310), together with an oracle (309) for performing quantum phase estimations involving sub-systems such as state initializer (310-1), Hadamard operators (310-b), control-U rotations block (310-c), IQFT-circuit (310-d), and quantum measurement (310-e), wherein the estimated spectrum is stored on a quantum register (311).
